(19) United States
(12) Patent Application Publication
(10) Pub. No.: US 2017/0284484 A1
(43) Pub. Date: Oct. 5, 2017

(54) ELECTROMAGNETIC CLUTCH FOR HIGH-PRESSURE PUMP

(71) Applicant: NLB Corp., Wixom, MI (US)

(72) Inventors: Albert John Bickmann, III, Howell, MI (US); Drew Waltenbaugh, Rochester Hills, MI (US)

(21) Appl. No.: 15/085,438

(22) Filed: Mar. 30, 2016

(51) Int. Cl. F16D 48/06; B08B 3/02; F16D 27/00

(52) U.S. Cl. CPC F16D 48/064; F16D 27/00; B08B 3/02; F16D 2300/22; F16D 2500/1022

(57) ABSTRACT

An example cleaning system includes an engine, a high-pressure pump, and an electromagnetic clutch assembly. The electromagnetic clutch assembly selectively couples the engine to the high-pressure pump such that actuation of the electromagnetic clutch assembly controls a supply of power from the engine to the high-pressure pump. An example electromagnetic clutch assembly is also disclosed.

### BACKGROUND

This application relates to an electromagnetic clutch for a high-pressure pump.

Typically, high-pressure pumps are powered by an engine that is coupled to the high-pressure pump by a drive shaft, either directly or indirectly by way of a power take-off unit. During operation of the engine, the pump pressurizes a flow of water, which is directed toward a surface to be cleaned either by a user or a robot, as examples. A user is capable of selectively interrupting the flow of high-pressure water by activating a trigger on a hand lance, for example. In known systems, although the flow is interrupted, the high-pressure pump continues to run. Thus, these known systems include one or more dump valves configured to dump excess high-pressure water to relieve pressure from the system.

### SUMMARY

An example cleaning system includes an engine, a high-pressure pump, and an electromagnetic clutch assembly. The electromagnetic clutch assembly selectively couples the engine to the high-pressure pump such that actuation of the electromagnetic clutch assembly controls a supply of power from the engine to the high-pressure pump.

An example electromagnetic clutch assembly for coupling and engine to a high-pressure pump includes a flywheel housed in a flywheel housing driven by an engine, and an electromagnetic clutch assembly mounted to the flywheel housing and connected to a drive shaft that drives a high-pressure pump.

These and other features of the present invention can be best understood from the following specification and drawings, the following of which is a brief description.

### DETAILED DESCRIPTION

The drawings can be briefly described as follows:

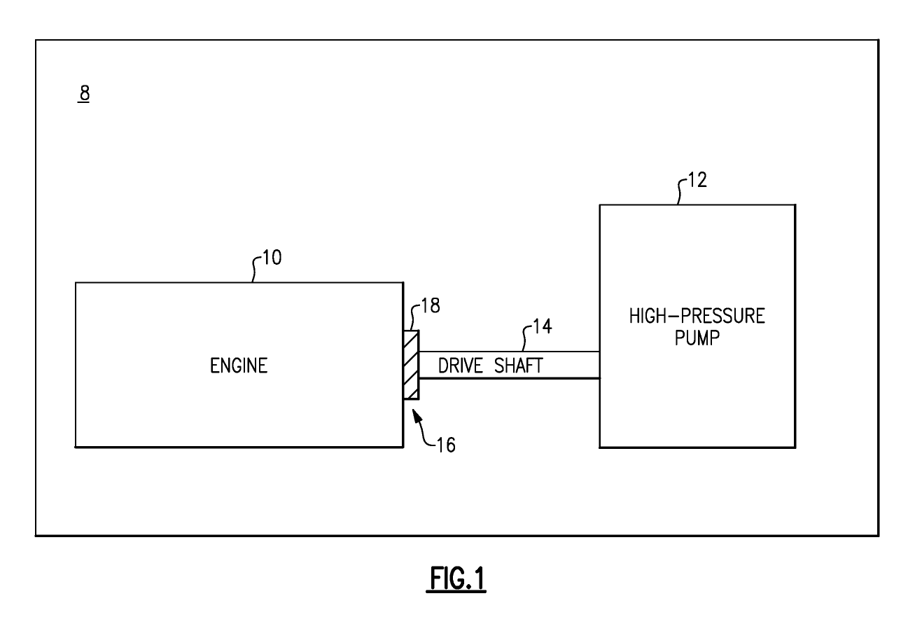

FIG. 1 schematically illustrates a system with an electromagnetic clutch assembly.

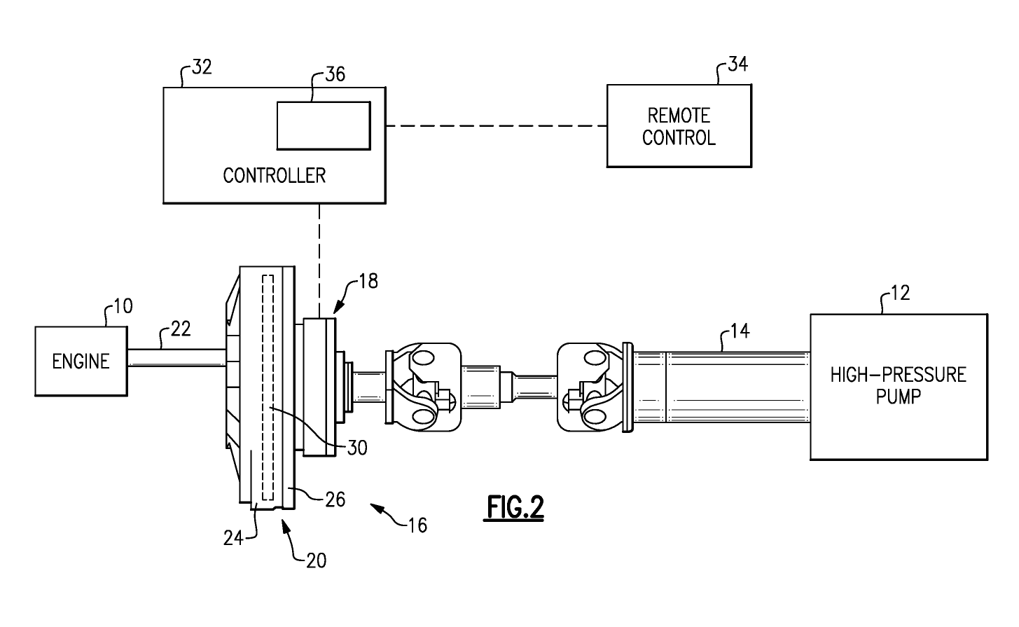

FIG. 2 schematically illustrates a detailed view of the electromagnetic clutch assembly of FIG. 1.

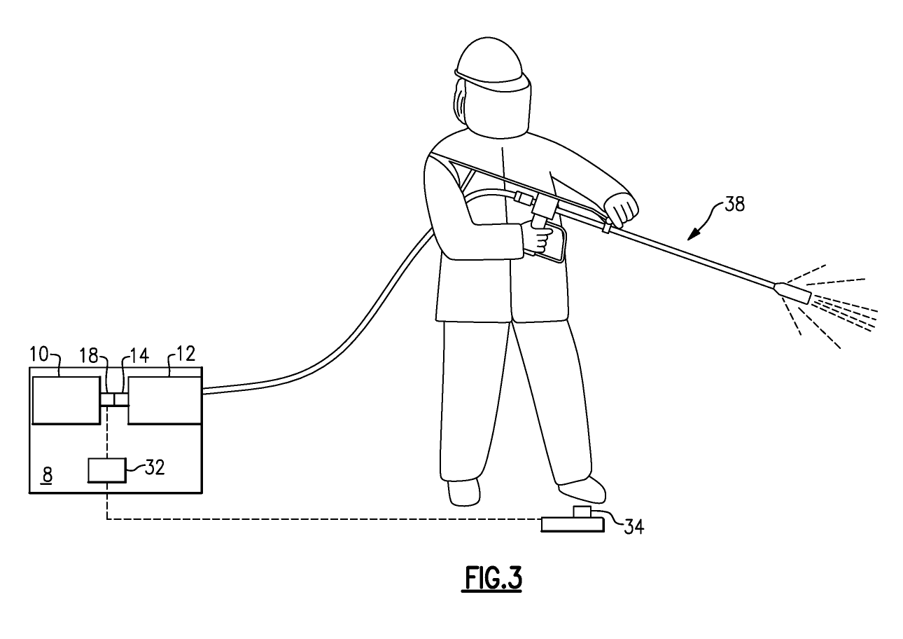

FIG. 3 schematically illustrates the system of FIG. 1 with a remote foot control.

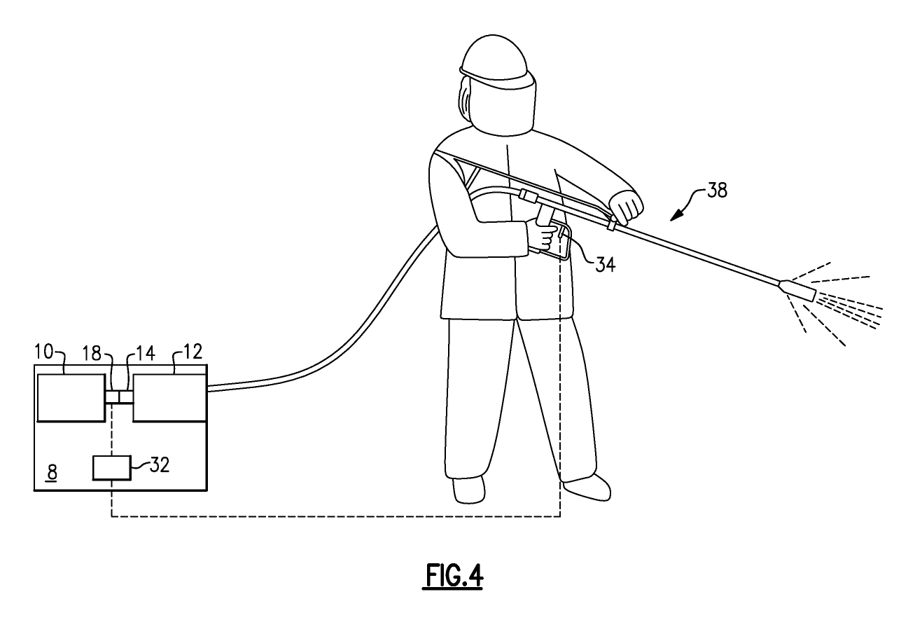

FIG. 4 schematically illustrates the system of FIG. 1 with a remote hand lance control.

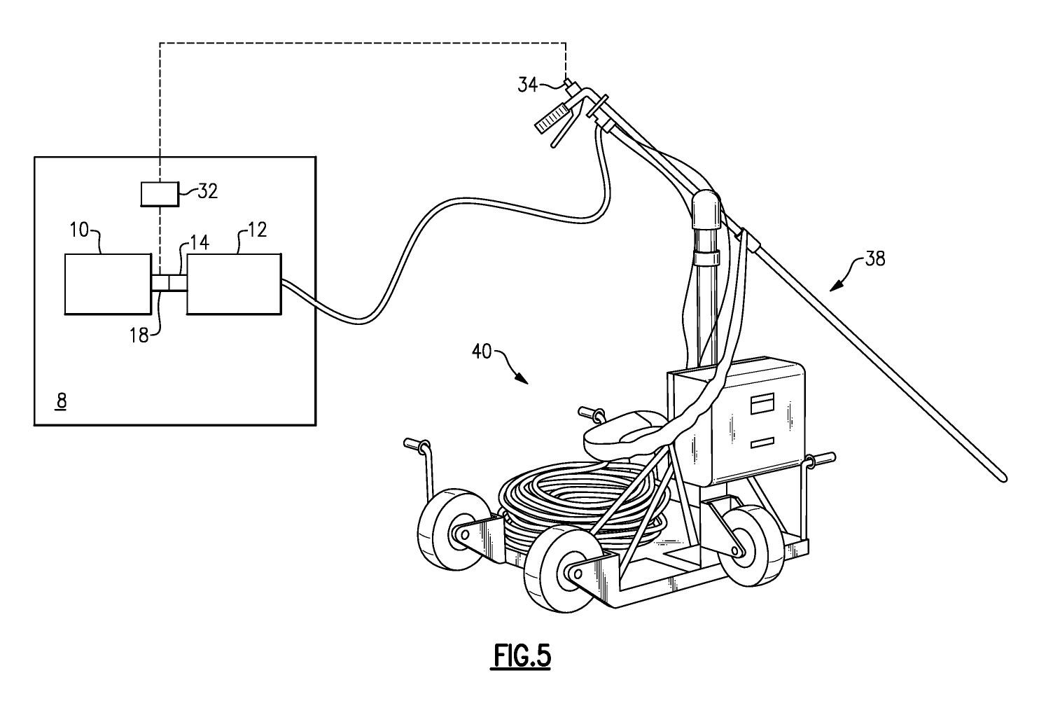

FIG. 5 schematically illustrates the system of FIG. 1 with a remote lance stand control.

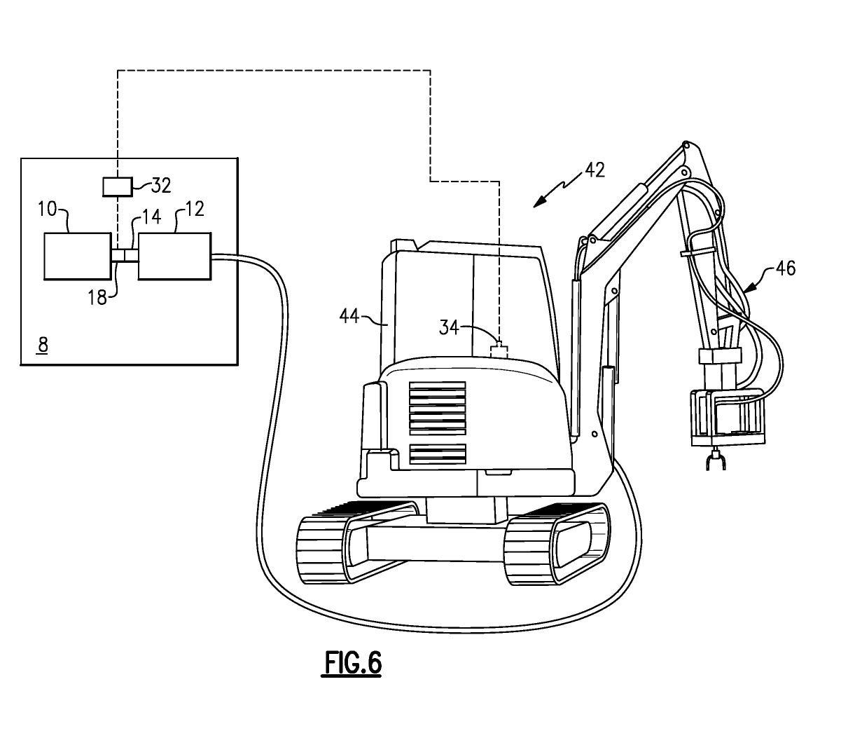

FIG. 6 schematically illustrates the system of FIG. 1 with a semi-automated cleaning system.

### DETAILED DESCRIPTION

This application relates to an electromagnetic clutch for an engine-driven, high-pressure water pump. FIG. 1 schematically illustrates an example high-pressure pump system 8. The example system 8 includes an engine 10 and a high-pressure pump 12. This disclosure is not limited to any particular pressure rating for the high-pressure pump 12, but example pressures include pumps capable of generating water pressures within a range of about 3,500 to 40,000 pounds per square inch (psi).

This disclosure extends to all types of engines configured for use with high-pressure pumps 12. In one example, the engine 10 is a diesel engine. In a further example, the engine 10 is a diesel engine with a power output of up to 450 horsepower (HP). This disclosure also extends to all types of high-pressure pumps, including high-pressure pumps for industrial cleaning applications. Further, while water is specifically referenced herein, the high-pressure pump 12 could be used to pressurize other fluids. In one example, the system 8 is mounted on a trailer, although the system 8 could be implemented in other contexts.

With continued reference to FIG. 1, the engine 10 drives the high-pressure pump 12 via a drive shaft 14. In this example, the engine 10 is selectively engaged with the high-pressure pump 12 by way of an electromagnetic clutch assembly 18. As will be explained below, the electromagnetic clutch assembly 18 allows an operator, for example, to selectively engage and disengage (or, couple and decouple) the high-pressure pump 12 from the engine 10, which selectively interrupts a flow of water without requiring a dump valve to dump excess water.

FIG. 2 schematically illustrates the detail of an example electromagnetic clutch assembly 18. In FIG. 2, the engine 10 is connected to, and drives, a flywheel 20 by a shaft 22. The flywheel 20 is housed inside a flywheel housing 24. In this example, the electromagnetic clutch assembly 18 includes a flywheel housing adapter plate 26 and a flywheel adapter plate 30. The flywheel housing adapter plate 26 is mounted to the flywheel housing 24. In this example, the flywheel adapter plate 30 is a torsional vibration dampening adapter, although other adapters come within the scope of this disclosure.

The electromagnetic clutch assembly 18 is mounted to the flywheel housing adapter plate 26. The flywheel adapter plate 30 drives the engine shaft 22 into the electromagnetic clutch assembly 18 via a splined interface (not shown), for example. In one example, the splined interface has a plurality of teeth. More specifically, the splined interface has between 10 and 15 teeth, and in one example has 13 teeth.

The electromagnetic clutch assembly 18 is electrically coupled to a controller 32. The controller 32 receives input signals from a remote control 34. The controller 32 is responsive to the input signals from the remote control 34, and the controller 32 is configured to cause the electromagnetic clutch assembly 18 to engage or disengage the drive shaft 14. In particular, the controller 32 is operable to control the level of current directed to the electromagnetic clutch, which engages or disengages the electromagnetic clutch assembly 18, thereby engaging and disengaging the motor 10 from the high-pressure pump 12.

In this disclosure, the controller 32 is electrically coupled to various components of the system 8. The controller 32 includes electronics, software, or both, to perform the necessary control functions for operating the electromagnetic clutch assembly 18. Although it is shown as a single device, the controller 32 may include multiple controllers in the form of multiple hardware devices, or multiple software controllers within one or more hardware devices.

When the electromagnetic clutch assembly 18 is disengaged from the drive shaft 14, no power is being transmitted from the engine 10 to the high-pressure pump 12, and the high-pressure pump 12 stops while the engine 10 may remain running. That is, when the electromagnetic clutch assembly 18 is disengaged, the engine 10 is not rotating the drive shaft 14, which is not driving the high-pressure pump 12. When the electromagnetic clutch assembly 18 is engaged with the drive shaft 14, the engine 10 rotates the drive shaft 14, which drives the high-pressure pump 12.

The remote control 34 allows the high-pressure pump 12 to be stopped and started while the engine 10 is running. This is safer to use than a manual Power Take-Off (PTO) and provides an ergonomic benefit as the operator will not need to physically access the electromagnetic clutch assembly 18. Also, the electromagnetic clutch assembly 18 is smaller and lighter that the PTO, so trailer size and cost can be reduced.

The remote control 34 can be connected to the controller 32 either by wired or wireless connection. In the wireless example, the controller 32 includes a wireless transceiver 36 for receiving signals from the remote control 34, which also includes a transceiver. This disclosure extends to various types of remote controls, and is not limited to any particular type of remote control.

In one example, shown in FIG. 3, the system 8 is connected to a lance 38. In this example, the lance 38 is a hand lance. The lance 38 receives water from the high-pressure pump 12 and the user moves the hand lance to direct high-pressure water to a surface to be cleaned. The remote control 34 in this example is a foot control. The foot control 34 allows a user to selectively engage or disengage the electromagnetic clutch using their feet while keeping both hands available to manipulate the lance 38. The remote control 34 can include one or more foot switches sized to accommodate a user's foot.

In another example, illustrated in FIG. 4, the remote control 34 is provided at the hand lance 38. Specifically, the remote control 34 may take the form of one or more buttons or triggers located adjacent a handle of the hand lance such that a user can conveniently access the remote control 34, yet located far enough away from the normal “use” position of the user's hand such that the remote control 34 is not unintentionally activated. An operator of the lance 38 can selectively engage and disengage the high-pressure pump 12 from the engine 10 using the remote control 34.

While in FIG. 3-4 the lance 38 is held in the hands of the user, in another example, shown in FIG. 5, the lance 38 can be supported on a lance stand 40. In that case, the remote control 34 can be incorporated into the lance stand 40.

Additionally, FIG. 6 illustrates another example in which the system 8 is used with a semi-automated cleaning system 42, such as the Automated Remote Manipulator (ARM) offered by NLB Corp. In this example, the semi-automated cleaning system 42 is driven by an operator, who sits within a cab 44 and controls a robotic arm 46. The robotic arm 46 directs high-pres sure water to a surface to be cleaned, per the corresponding instructions provided by the operator. The remote control 34 is provided within the cab 44 in this example. Alternatively, the semi-automated cleaning system 42 could be driven robotically, in which case the remote control 34 would be incorporated into the control panel for the robotic drive.

While FIGS. 3-6 illustrate three example remote control 34 locations, this disclosure extends to other locations for the remote control 34. Further, while a particular hand lance is illustrated in FIGS. 3-5, the lance 38 can be a rotating lance or any other type of lance.

While FIGS. 1-6 illustrate several applications for the example system 8, the system 8 can be used in a variety of applications having high-pressure pumps, especially those for cleaning. Example applications include rotary hose devices; bundle cleaning apparatuses including semi- and fully-automated bundle cleaning apparatuses for internal and/or external bundle cleaning; automated remote manipulators; floor and grate cleaners including powered/self-rotating cleaners; vertical surface cleaners; and/or stripe removal trucks.

In all of these applications, the electromagnetic clutch assembly 18 eliminates maintenance because physical interaction, grease, and adjustment are not required. Additionally, it allows the engine 10 to idle at a lower rotational speed (or, RPM), which results in fuel savings along with reduced wear and noise. Furthermore, when the high-pressure pump 12 is disengaged the engine 10 may be idling. Thus, torque requirements are reduced and a lower horsepower engine 10 can be used. There will also be less wear on the high-pressure pump 12 with the reduced uptime and because the high-pressure pump 12 is not constantly running.

As discussed, the electromagnetic clutch assembly 18 allows for an auto-shutoff feature for the high-pressure pump 12. This allows for a shutoff of system water flow, which facilitates a dry shut-off for accessories (such as the lance 38) connected to the high-pressure pump 12. The electromagnetic clutch assembly 18 thus eliminates the need for downstream valves, such as dump valves, since the water shut-off can be done by disengaging the engine 10 from the high-pressure pump 12. Dump valves are typically used a means of pressure release. With a dry shut-off, however, pressure release is not necessary because fluid flow is stopped upstream of accessories, and pressure does not build up in downstream piping or accessories after the shut-off.

With the dump valves being eliminated, an air compressor may also not be required, further reducing cost. Water usage is also reduced with the auto-shutoff feature. The electromagnetic clutch assembly 18 also allows the elimination of a throttle switch to further reduce cost. This in turn reduces the necessary accessory manifold size for the high-pressure pump 12.

Although the different examples have the specific components shown in the illustrations, embodiments of this disclosure are not limited to those particular combinations. It is possible to use some of the components or features from one of the examples in combination with features or components from another one of the examples.

One of ordinary skill in this art would understand that the above-described embodiments are exemplary and non-limiting. That is, modifications of this disclosure would come within the scope of the claims. Accordingly, the following claims should be studied to determine their true scope and content.

1. A cleaning system, comprising:
an engine;
a high-pressure pump; and
an electromagnetic clutch assembly selectively coupling the engine to the high-pressure pump such that actuation of the electromagnetic clutch assembly controls a supply of power from the engine to the high-pressure pump.

2. The system recited in claim 1, where in the high-pressure pump is a high-pressure water pump.

3. The system recited in claim 2, wherein disengagement of the electromagnetic clutch assembly shuts off water supply to the system.

4. The system as recited in claim 1, wherein the engine is a diesel engine.

5. The system as recited in claim 4, wherein the diesel engine has a power output of up to 450 HP.

6. The system as recited in claim 1, wherein the electromagnetic clutch assembly controls rotation of a drive shaft which drives the high-pressure pump.

7. The system as recited in claim 1, further comprising a controller configured to engage and disengage the electromagnetic clutch assembly.

8. The system as recited in claim 7, further comprising a remote control configured to communicate a signal to the controller, the signal instructing the controller to engage or disengage the electromagnetic clutch assembly.

9. The system as recited in claim 8, wherein the remote control is part of a lance.

10. The system as recited in claim 8, wherein the remote control is a foot control.

11. The system as recited in claim 8, wherein the remote control communicates wirelessly with a wireless receiver on the controller.

12. The system as recited in claim 8, wherein the remote control is wired to the controller.

13. The system as recited in claim 8, wherein:
the system includes semi-automated cleaning system having a cab and a robotic arm, and
the remote control is provided within the cab.

14. The system as recited in claim 1, wherein the system excludes dump valves.

15. An electromagnetic clutch assembly for coupling and engine to a high-pressure pump, comprising:
a flywheel housed in a flywheel housing driven by an engine; and
an electromagnetic clutch assembly mounted to the flywheel housing and connected to a drive shaft that drives a high-pressure pump.

16. The electromagnetic clutch assembly of claim 15, wherein the electromagnetic clutch assembly is mounted to the flywheel housing via a flywheel adapter.

17. The electromagnetic clutch assembly of claim 15, wherein the flywheel adapter is a torsional vibration dampening adapter.

18. The electromagnetic clutch assembly of claim 17, wherein the flywheel adapter drives a shaft of the engine into the electromagnetic clutch assembly via a splined interface.

19. The electromagnetic clutch assembly as recited in claim 15, further comprising a controller configured to engage and disengage the electromagnetic clutch assembly.

20. The electromagnetic clutch assembly as recited in claim 19, further comprising a remote control configured to communicate a signal to the controller, the signal instructing the controller to engage or disengage the electromagnetic clutch assembly.
